(19) United States
(12) Patent Application Publication
(10) Pub. No.: US 2012/0192680 A1
(43) Pub. Date: Aug. 2, 2012

(54) Fabricated Mill Body with Blade Pockets for Insert Placement and Alignment

(75) Inventor: James S. Trahan, Magnolia, TX (US)

(73) Assignee: BAKER HUGHES INCORPORATED, Houston, TX (US)

(21) Appl. No.: 13/014,797

(22) Filed: Jan. 27, 2011

(51) Int. Cl. B23P 15/28

(52) U.S. Cl. 76/108.2

(57) ABSTRACT

A mill body is machined integrally with blades that have pockets to receive PDC inserts. The insert pockets can have an orientation feature to ensure that inserts that require specific rotational orientation are put into the pockets at the right orientation for efficient milling. The orientation of some of the pockets closest to the bottom and center of the bit have their axis reoriented to a near parallel orientation to the bit center axis to allow the bit body and blade fabrication equipment access to drill the insert pocket.

### FIELD OF THE INVENTION

The field of the invention is mills for subterranean use and more particularly mills that have a fabricated body with blade pockets for placement and alignment of inserts.

### BACKGROUND OF THE INVENTION

Mills that are used for making casing exits typically have a cast body with a series of blades. Each blade has an array of polycrystalline diamond inserts commonly referred to as PDC inserts. In some designs the inserts are cylindrically shaped and disposed on each blade in a specific arrangement that uses a nesting feature where inserts in one row are offset from inserts in the row that is above. Because of this arrangement the load during milling is better distributed to prevent body damage and increase mill longevity. In a given row of inserts there is also an optimum center to center spacing of the inserts.

Cast bodies such as those described in U.S. Pat. No. 7,117,960 have been used. These bodies require the blades to be integrated or machined with the bit body. Other designs had welded blades to the bodies using welding techniques that employ high temperatures and can cause stresses in the body at the attachment locations. Some designs use fully cast bodies with pockets in the casting for inserts as illustrated in U.S. Pat. No. 7,178,609. The illustrated design is a dual function mill for making a casing exit and continuing to drill a lateral wellbore. The cast bodies involved a single use mold which made the bits extremely expensive.

Casing exit mills typically have blades that are welded to a machined body using welding techniques that employ high temperatures and can cause stresses in the body at the attachment locations. Additionally for initial assembly there was a logistics problem of stocking separate bit bodies, blades and inserts. Typically the blades were manufactured with flat faces that created placement variability in the insert positioning.

Until recently, machining equipment was not sophisticated enough to machine a mill body with integrated blades. The insert placement on the blades particularly on the lower end of the mill also presented a problem if pockets were to be machined into the blades. Near the bottom center of the mill the spacing was so close as to preclude a milling machine from making the bore that could be the receptacle for an insert. This was because the orientation of the inserts was at that location generally perpendicular to the longitudinal rotation axis creating a clearance too small to allow the machining equipment access to the blade location without interfering with the adjacent receptacle. Apart from all these reasons was that with the level of machining technology available until recently it was not considered economically feasible to machine bodies with integral blades and insert pockets. Often overlooked in such an analysis was the logistical cost of stocking cast bodies apart from blades for specific bodies and inserts for specific blades.

The present invention overcomes the problems with cast bodies described above and offers a machined body with integral blades that have pockets at a desired spacing and further offers the option of a guide for the inserts in the pockets should they have a cutting end that needs positioning in a specific orientation to function properly. Some of the pockets feature a near parallel to the rotational axis orientation to facilitate machining those pockets. Those skilled in the art will fully appreciate the present invention from a review of the detailed description and the associated drawings while understanding that the full scope of the invention is to be determined from the appended claims.

### SUMMARY OF THE INVENTION

A mill body is machined integrally with blades that have pockets to receive PDC inserts or tungsten carbide. The insert pockets can have an orientation feature to ensure that inserts that require specific rotational orientation are put into the pockets at the right orientation for efficient milling. The orientation of some of the pockets closest to the bottom and center of the bit have their axis reoriented to a near parallel orientation to the bit center axis to allow the bit body and blade fabrication equipment access to drill the insert pocket.

### BRIEF DESCRIPTION OF THE DRAWINGS

FIG. 1 is a perspective view of the fabricated mill showing the insert placement;

FIG. 2 is a close up view of the blade area of the mill in FIG. 1;

FIG. 3 is a bottom view of the mill of FIG. 1; and

FIG. 4 is a detailed view of a pocket showing the orientation feature of an insert when inserted into the pocket for attachment.

### DETAILED DESCRIPTION OF THE PREFERRED EMBODIMENT

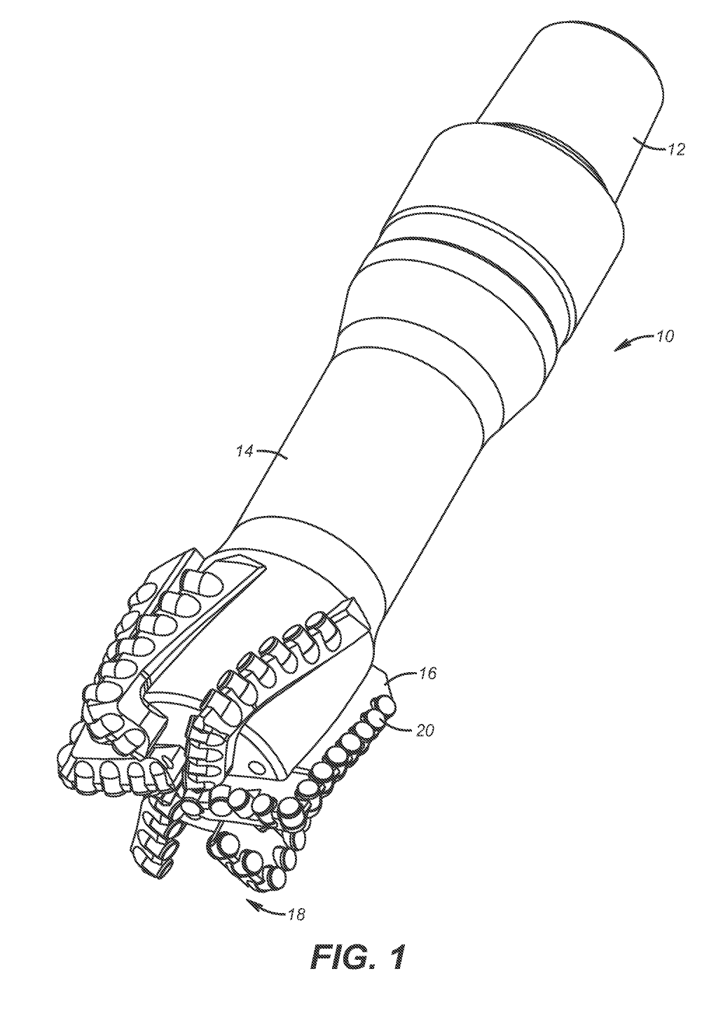

As shown in FIG. 1 the mill 10 has a threaded end connection 12 leading to an elongated body 14 that has a series of blades 16 at a lower end 18. Inserts 20 are illustrated as cylindrical shapes but can have non-symmetrical shapes that require a preferred orientation. This concept is illustrated in FIG. 4 where an insert 20 has a key 24 that goes into a shaped pocket 22 in the blade 16 only one way so that the cutting face 26 is oriented in a proper direction with respect to a central axis of the insert 20 for optimal cutting efficiency.

The assembly shown in FIG. 1 is fabricated from an initial shape so that the body 14, along with the end threads 12 and the blades 16 and the array of pockets 22 can be manufactured as an integral structure. The advantages offered by this fabrication technique is that the dressing of the blades before initial use is uniform and predictable as the array of pockets 22 are placed on each blade 16 and with respect to adjacent inserts 20 in a precise layout because the pockets that are also part of the fabrication technique are precision machined for layout and spacing as well as depth of the pockets 22. The inserts 20 can then be brazed to the blade 16 when in the corresponding pocket 22. The brazing or other equivalent low temperature technique to secure the inserts 20 to their pockets 22 avoids stress being induced between the blades 16 and the body 14 as can happen when the blades have to be welded to the bit body as in the past. The machining of pockets 22 assures the desired array on each blade and the desired extension from the blade surface.

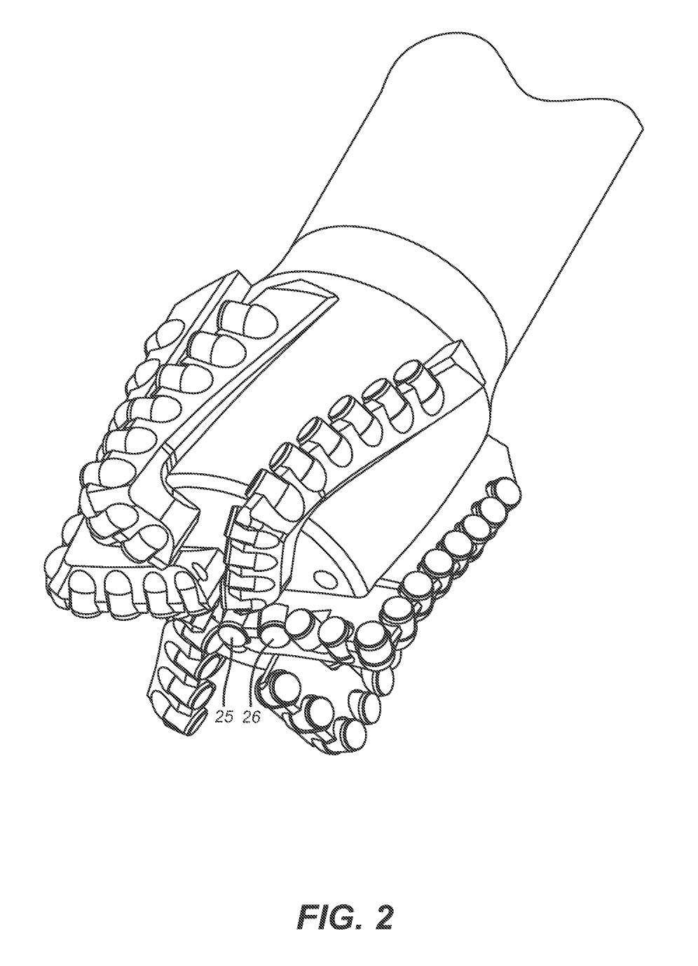

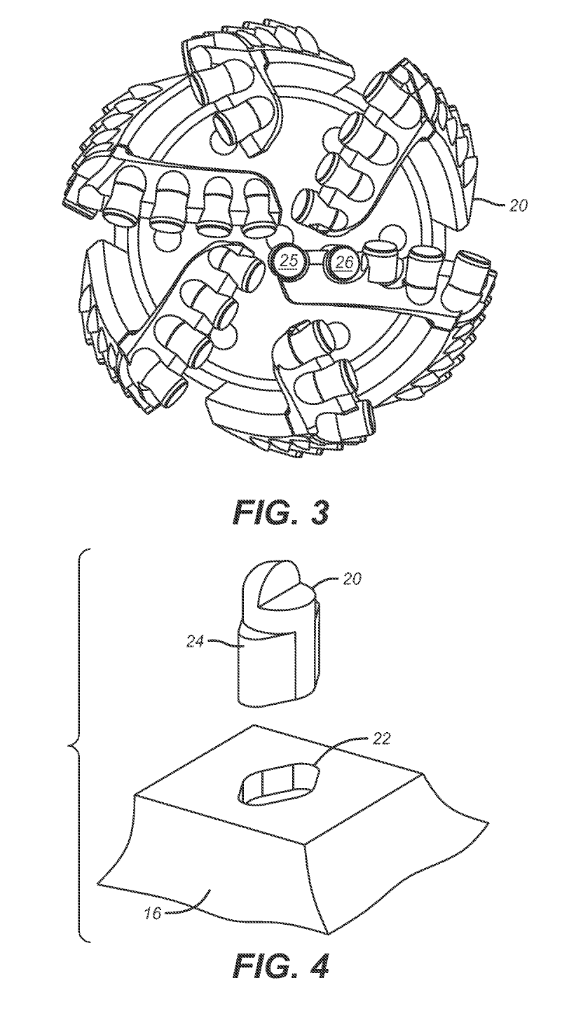

FIGS. 2 and 3 shows inserts 25 and 26 that have an axis rotated approximately 90 degrees from adjacent inserts 20. This is done so that the pockets 22 for the inserts 25 and 26 can be machined with the equipment that fabricates the body 14 and the blades 16. With insert locations closest to the center and bottom of the body 14 there can be an issue of equipment access to drill the pocket 22 and interference with adjacent pockets so this problem is avoided by reorienting the axis of the pocket and the subsequent insert that is brazed into it so that the pocket can be produced.

Those skilled in the art will appreciate that the production technique results in a unitary bit and blade arrangement where the blades have properly spaced pockets of the desired depth and orientation. The inserts are then inserted in the pockets and preferably brazed although other techniques can be used. For inserts that have to be installed in a proper orientation about their longitudinal axes there can be a keyway in a groove in the pocket or the opposite orientation where the key is in the pocket and a matching groove in the insert so that the inserts are in the proper orientation about their longitudinal axes when inserted to be brazed. Some of the pockets can be oriented closer to alignment with the axis of the body 14 to allow access for the machining equipment to make the pocket in what would otherwise be a tight or impossible fit without the reorientation for specific pockets.

Another advantage accrues during the initial assembly in that the inserts are all properly arrayed and at the proper extension from the blade face. Even if the mill is to be redressed after use with fresh inserts, the same advantage still accrues assuming the blades are all in adequate structural condition and the worn inserts carefully removed from their respective pockets.

The unitary structure of the body with the blades takes away a logistical concern of stocking different size blades to go with unique bodies and removes the added body stress from welding the blades to the body in a remote location from the manufacturing facility. While using computer controlled machining techniques to produce the mill with integral blades and pockets is initially more costly, the higher performance that can be obtained at the subterranean location can more than compensate for the initial cost difference over current cast body techniques. The pockets can either be initially machined as the blades are produced or if desired can be omitted to reduce cost of fabrication or to allow alternative insert configurations to be used on any given blade.

The above description is illustrative of the preferred embodiment and many modifications may be made by those skilled in the art without departing from the invention whose scope is to be determined from the literal and equivalent scope of the claims below:

I claim:

1. A manufacturing method for a mill, comprising:
integrally machining a mill body and a blade assembly extending from said body;
integrally machining a plurality of pockets on at least one of said blades.

2. The method of claim 1, comprising:
inserting inserts into said pockets.

3. The method of claim 2, comprising:
securing said insert when placed in said pocket to the surrounding blade that defines said pocket.

4. The method of claim 3, comprising:
joining said insert placed in said pocket by brazing said insert to a surrounding blade.

5. The method of claim 1, comprising:
disposing said pockets in a predetermined array at the blade periphery.

6. The method of claim 5, comprising:
making the pockets of the same depth.

7. The method of claim 5, comprising:
orienting the central axis of some pockets on a predetermined blade at a different angle with respect to the body axis than other pockets on the predetermined blade.

8. The method of claim 7, comprising:
locating said pockets with the different angle for their central axes near to bottom center of the body.

9. The method of claim 2, comprising:
using an asymmetrical insert;
providing an orienting feature on the asymmetrical insert and a pocket that receives said asymmetrical insert that only allows advancing the asymmetrical insert into a pocket in a single orientation.

10. The method of claim 9, comprising:
placing a key on an insert and a groove a pocket to accept said key to insure a desired orientation of said insert.

11. The method of claim 4, comprising:
using an asymmetrical insert;
providing an orienting feature on the asymmetrical insert and a pocket that receives said asymmetrical insert that only allows advancing the asymmetrical insert into a pocket in a single orientation.

12. The method of claim 11, comprising:
placing a key on an insert and a groove a pocket to accept said key to insure a desired orientation of said insert.

13. The method of claim 11, comprising:
disposing said pockets in a predetermined array at the blade periphery.

14. The method of claim 13, comprising:
making the pockets of the same depth.

15. The method of claim 13, comprising:
orienting the central axis of some pockets on a predetermined blade at a different angle with respect to the body axis than other pockets on the predetermined blade.

16. The method of claim 15, comprising:
locating said pockets with the different angle for their central axes near to bottom center of the body.
